(19) United States
(12) Patent Application Publication
(10) Pub. No.: US 2015/0025680 A1
(43) Pub. Date: Jan. 22, 2015

(54) VENDING MACHINE

(71) Applicant: Sihui Han, Rancho Cucamonga, CA (US)

(72) Inventor: Sihui Han, Rancho Cucamonga, CA (US)

(21) Appl. No.: 13/943,522

(22) Filed: Jul. 16, 2013

(51) Int. Cl. G07F 7/00

(52) U.S. Cl. CPC G07F 7/005
USPC 700/236; 700/232; 221/277

(57) ABSTRACT

A vending machine is disclosed. The vending machine may include a main body, a pathway, a shaft having a circular surface and a receiving space, a selection button, a sliding path, an opening, a plurality of merchandises and a payment managing system, wherein one or more merchandises are disposed in each pathway and the merchandises are supported by the circular surface of the shaft, wherein when the merchandise is selected and payment has been processed by the payment managing system, the shaft starts to rotate and the selected merchandise is received in the receiving space during the rotation of the shaft and dispensed to the sliding path and opening.

### FIELD OF THE INVENTION

The present invention relates to a vending machine, and more particularly to a vending machine that has a simple structure and is easy to use.

### BACKGROUND OF THE INVENTION

There are many types of vending machines to sell drinks, food, cigarettes, candies, napkins, etc. The mechanical structure of the vending system (such as current spring tray structure) in the vending machines is complicated, expensive and difficult to maintain, which adversely affects further promotion of the vending machines. Therefore, there remains a need for a new and improved structure of vending machines to overcome the problem stated above.

### SUMMARY OF THE INVENTION

It is an object of the present invention to provide a vending machine that is easy to maintain and operate.

It is another object of the present invention to provide a vending machine that has simple mechanical structure to dispense the merchandises therein.

It is a further object of the present invention to provide a vending machine that can be adjusted to accommodate different sizes of merchandises.

In one aspect, a vending machine may include a main body, a pathway, a shaft, a selection button. The size of the pathway can be adjusted according the size of the merchandise. Underneath each pathway is the shaft, half of which is circular and the other half of which is a receiving space. The shaft can be rotated and controlled by a decelerating unit. When the shaft is in a standby mode, the circular half of the shaft is used to support the merchandises thereabove, and when the user has selected and paid for the merchandise above the shaft, the shaft starts to rotate and the merchandise right above the shaft will be finally received in the receiving space during the rotation of the shaft.

The shaft continues to rotate until the receiving space faces down to drop the merchandise into the sliding path then to the opening for the user to pick up. The shaft would continue to rotate until the circular half rotates to its original position to support the merchandise thereabove.

### BRIEF DESCRIPTION OF THE DRAWINGS

FIG. 1 illustrates a schematic view of a vending machine in the present invention.

FIG. 2 illustrates a schematic view of standby mode of the shaft in the vending machine in the present invention.

FIGS. 3 and 3a illustrate a schematic view of the rotation of the shaft to dispense the merchandise in the present invention.

FIG. 4 illustrates a schematic view of the payment managing system in the present invention.

FIG. 5 illustrates an assembled view of the vending machine in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

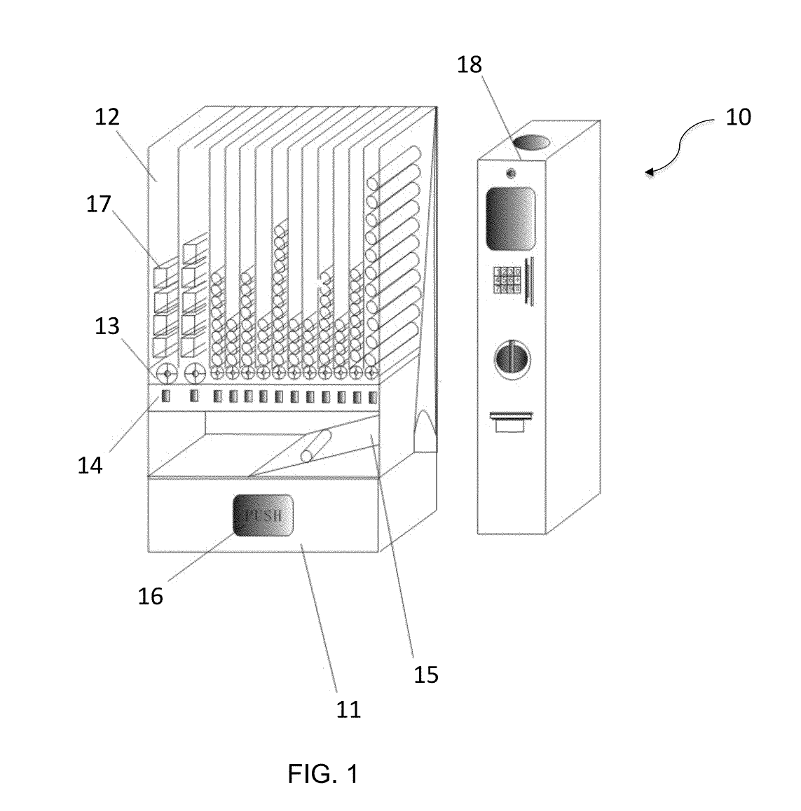

As shown in FIG. 1, a vending machine 10 may include a main body 11, a pathway 12, a shaft 13, a selection button 14. The vending machine 10 may also include a sliding path 15, an opening 16, a plurality of merchandises 17 and a payment managing system 18. The size of the pathway 12 is adjustable to accommodate merchandises with different sizes. Underneath each pathway 12 is the corresponding shaft 13 and selection button 14. Customers can select different merchandises in different pathways 12 and after finishing the payment process through the payment managing system 18, the shaft 13 starts to rotate so that the merchandise that is closest to the shaft can be rolled out from the pathway 12 to the sliding path 15 then to the opening 16.

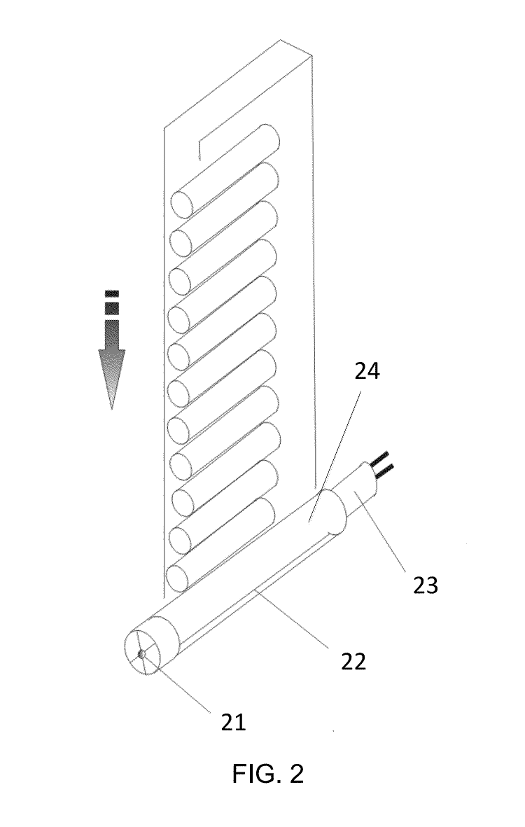

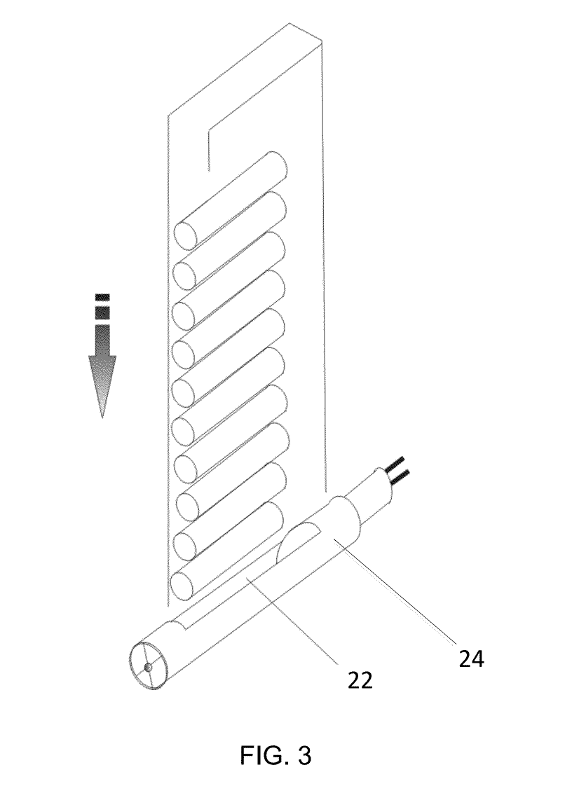

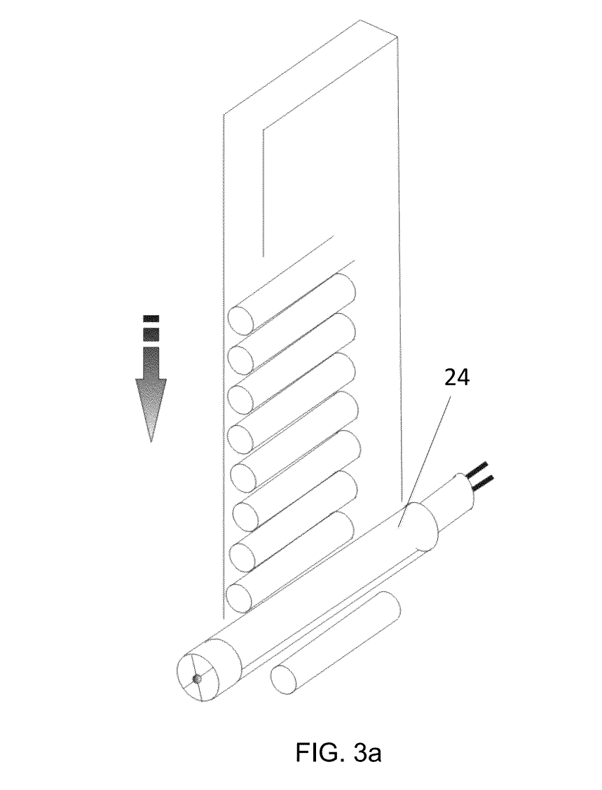

More specifically, as shown in FIGS. 2, 3 and 3a, the shaft 13 can be divided into two portions: a circular surface 24 and a receiving slot 22. When the shaft 13 is at a standby mode, the circular surface 24 is used to support the merchandise thereabove. The shaft 13 may also include an adjusting latch 21 and a decelerating unit 23 to drive the shaft 13. When the shaft 13 is triggered after the user finishes the payment process, it starts to rotate so the receiving slot 22 can receive the merchandise thereabove, and the shaft 13 continues to rotate to transport the merchandise to the sliding path 15 then to the opening 16, as shown in FIGS. 3 and 3a.

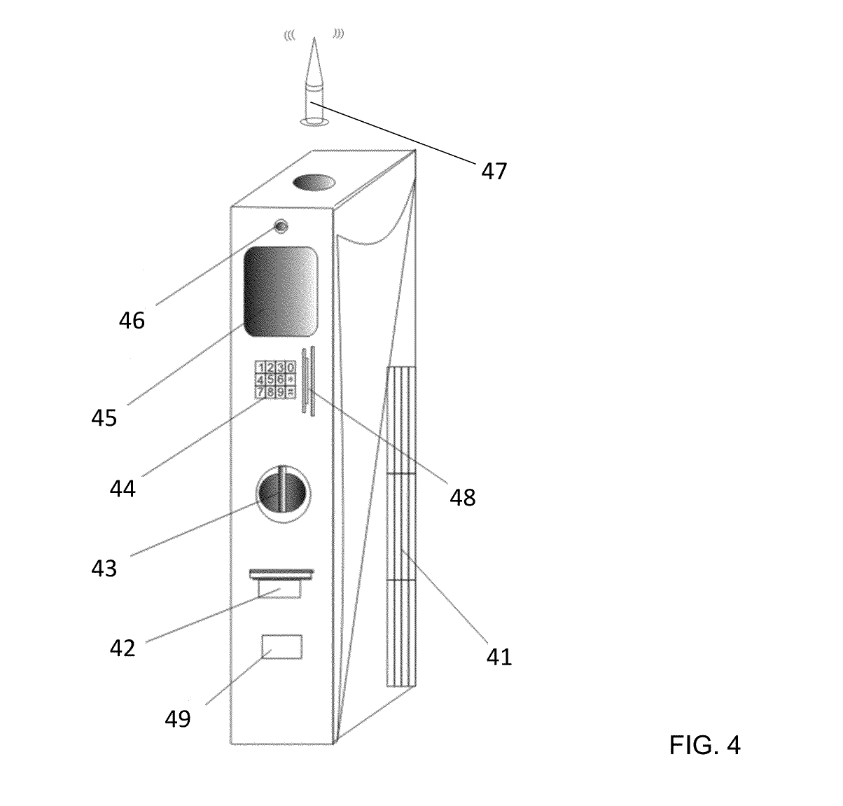

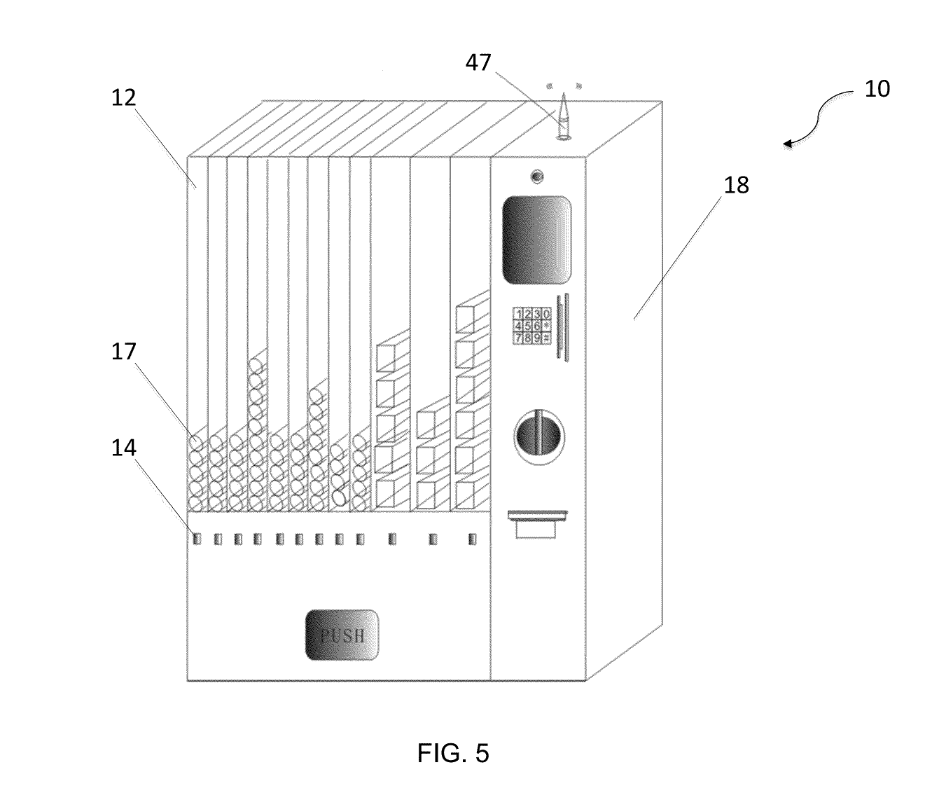

As shown in FIGS. 4 and 5, the payment managing system 18 has a control system 41, a bill-receiving slot 42, a coin-receiving slot 43 and a cell phone payment configuration 44. The payment managing system 18 also has a LCD touch screen 45, a credit card reader 48 and a two-dimensional code reader 49, so that the user can have more options other than paying cash. In one embodiment, the control system 41 has a micro-computer system to perform the functions of receiving/transmitting information, statistics, accounting, fault-diagnosis and other managerial functions. The micro-computer system can also be used to control the display of merchandise information, price information and inquiries. In another embodiment, the micro-computer system of the control system 41 is operatively connected with the bill-receiving slot 42, coin-receiving slot 43, cell phone payment configuration 44, LCD touch screen 45, credit card reader 48 and the two-dimensional code reader 49. In a further embodiment, the control system 41 can be controlled remotely through LAN, WIFI, 3G/4G network (47). A surveillance system 46 can also be installed in the payment managing system 18. In still a further embodiment, the decelerating unit 23 can be replaced by a knob, so the user can manually operate the knob to retrieve the merchandise after the payment process.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A vending machine comprising a main body, a pathway, a shaft having a circular surface and a receiving space, a selection button, a sliding path, an opening, and a payment managing system, wherein one or more merchandises are disposed in each pathway and the merchandises are supported by the circular surface of the shaft, and when the merchandise is selected and payment has been processed by the payment managing system, the shaft starts to rotate and the selected merchandise is moved with the shaft and finally received in the receiving space during the rotation of the shaft, and the merchandise is then dispensed to the sliding path and opening for the user to retrieve.

2. The vending machine of claim 1, wherein the payment managing system has a control system that has a micro-computer, a bill-receiving slot, a coin-receiving slot and a cell phone payment configuration.

3. The vending machine of claim 2, wherein the control system is controlled remotely through LAN, WIFI, 3G/4G network.

4. The vending machine of claim 2, the payment managing system further comprising a LCD touch screen, a surveillance system, a credit card reader and a two-dimensional code reader.

5. The vending machine of claim 2, wherein the micro-computer is used to perform the functions of receiving/transmitting information, statistics, accounting, fault-diagnosis and other managerial functions.

6. The vending machine of claim 2, wherein the micro-computer system is operatively connected with the bill-receiving slot, coin-receiving slot, cell phone payment configuration, LCD touch screen, credit card reader and the two-dimensional code reader.

7. The vending machine of claim 5, wherein the micro-computer system is operatively connected with the bill-receiving slot, coin-receiving slot, cell phone payment configuration, LCD touch screen, credit card reader and the two-dimensional code reader.

8. The vending machine of claim 1, wherein the shaft includes an adjusting latch and a decelerating unit to drive the shaft.
